(19) United States
(12) Patent Application Publication
(10) Pub. No.: US 2014/0247269 A1
(43) Pub. Date: Sep. 4, 2014

(54) HIGH DENSITY, LOW LOSS 3-D THROUGH-GLASS INDUCTOR WITH MAGNETIC CORE

(71) Applicant: QUALCOMM MEMS Technologies, Inc., (US)

(72) Inventors: David Francis Berdy, West Lafayette, IN (US); Jonghae Kim, San Diego, CA (US); Chengjie Zuo, Santee, CA (US); Daeik Daniel Kim, San Diego, CA (US); Changhan Hobie Yun, San Diego, CA (US); Mario Francisco Velez, San Diego, CA (US); Je-Hsiung Jeffrey Lan, San Diego, CA (US)

(73) Assignee: QUALCOMM MEMS Technologies, Inc., San Diego, CA (US)

(21) Appl. No.: 13/784,580

(22) Filed: Mar. 4, 2013

(51) Int. Cl. H01F 17/00; H01F 41/14; G06T 1/00

(52) U.S. Cl. CPC H01F 17/0006; G06T 1/00; H01F 41/14
USPC 345/501; 336/200; 427/129; 216/39; 264/400; 264/427

(57) ABSTRACT

This disclosure provides systems, methods and apparatus for three-dimensional (3-D) through-glass via inductors. In one aspect, the through-glass via inductor includes a glass substrate with a first cavity, a second cavity, and at least two through-glass vias. The through-glass vias include metal bars that are connected by a metal trace. The metal bars and the metal trace define the inductor, and each cavity is at least partially filled with magnetic material. The magnetic material can include a plurality of particles having an average diameter of less than about 20 nm. The first cavity can be inside the inductor and the second cavity can be outside inductor. In some implementations, the first and the second cavity can be vias that extend only partially through the glass substrate.

### TECHNICAL FIELD

This disclosure relates generally to through substrate via inductors and more particularly to three-dimensional (3-D) through-glass via inductors.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Inductors are ubiquitous analog electronic components that are used in a myriad of power regulation, frequency control, and signal conditioning applications in a range of devices including personal computers, tablet computers, and wireless mobile handsets. An inductor stores energy in its magnetic field. The performance of an inductor can relate to the quality (O) factor, which can be expressed by Q=ω₀L/R, where ω₀ is the resonant frequency, L is the inductor value or inductance, and R is the resistance.

Real inductors have a finite quality factor meaning that in addition to storing energy in an induced magnetic field, they also dissipate energy through ohmic and magnetic losses. Moreover, inductors may require large physical dimensions (on the order of millimeters) in order to achieve inductance values greater than tens of nanohenries (nH). Some inductors are fabricated with cores made of a high magnetic permeability material, which increases their inductance density. Due to challenges associated with designing and fabricating inductors with the requisite form factor, quality factor, and inductance density, inductors are often discrete components that are integrated with other discrete and integrated electronic elements at the board level.

### SUMMARY

The systems, methods and devices of this disclosure each have several innovative aspects, no single one of which is solely responsible for the desirable attributes disclosed herein.

One innovative aspect of the subject matter described in this disclosure can be implemented in a device including a glass substrate, a first cavity defined in the glass substrate, and a second cavity defined in the glass substrate, where magnetic material is both the first and the second cavity. The device further includes at least two through-glass vias extending through the glass substrate, where the at least two through-glass vias include metal bars, and where the first cavity is between the through-glass vias and at least one of the through-glass vias is between the first cavity and the second cavity. The device further includes a metal trace connecting the metal bars between the at least two through-glass vias.

In some implementations, the magnetic material can include a plurality of magnetic particles, where the average diameter of the particles is less than about 20 nm. In some implementations, the magnetic particles can be substantially coated with insulating material. The insulating material can include silicon oxide (SiOx). The average thickness of the coating can be between about 5 nm and about 100 nm. In some implementations, the device can include a third cavity defined in the glass substrate, where magnetic material is disposed in the third cavity, and where the metal bars are between the second cavity and the third cavity. In some implementations, each of the first and the second cavity is a via extending only partially through the glass substrate. In some implementations, an apparatus can include the aforementioned device, a display, and a processor configured to communicate with the display, the processor being configured to process image data. The apparatus can further include a driver circuit configured to send at least one signal to the display and a controller configured to send at least a portion of the image data to the driver circuit. The apparatus can further include an image source module configured to send the image data to the processor, where the image source module includes at least one of a receiver, transceiver, and transmitter, and an input device configured to receive input data and to communicate the input data to the processor.

Another innovative aspect of the subject matter described in this disclosure can be implemented in a method including forming at least two through-glass vias extending through a glass substrate, forming a first cavity in the glass substrate, where the first cavity is between the at least two through-glass vias, and forming one or more second cavities in the glass substrate, where at least one of the through-glass vias is between the first cavity and the one or more second cavities. The method further includes depositing magnetic material in the first and in the one or more second cavities, depositing metal to at least partially fill the through-glass vias to form metal bars in the through-glass vias, and depositing a metal trace between the through-glass vias to connect the metal bars.

In some implementations, the magnetic material can include a plurality of magnetic particles, where the average diameter of the magnetic particles is less than about 20 nm. In some implementations, the method further includes coating the magnetic particles with insulating material. The insulating material can include silicon oxide (SiOx). In some implementations, the insulating material can be graphene, surfactants, polymers, or other passivation material. The thickness of the coating can be between about 5 nm and about 100 nm. In some implementations, each of the first cavity and the one or more second cavities is a via extending only partially through the glass substrate. In some implementations, forming the at least two through-glass vias and forming the first and the one or more second cavities occur simultaneously or at different times.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A is an example of a flow diagram illustrating a method of manufacturing a through-glass via inductor.

FIG. 1B is another example of a flow diagram illustrating a method of manufacturing a through-glass via inductor.

FIGS. 2A-2E are examples of cross-sectional schematic side and top views of various stages of manufacturing a through-glass via inductor.

FIG. 3 is an example of a perspective view of an isometric projection of a through-glass via inductor.

FIG. 4 is an example of a flow diagram illustrating a method of manufacturing a through-glass via inductor with a cavity having magnetic material.

FIGS. 5A-5F are examples of cross-sectional schematic side views of various stages of manufacturing a through-glass via inductor with a cavity having magnetic material.

FIG. 6 is an example illustrating a magnified view of magnetic material including a plurality of particles.

FIG. 7 is an example of a flow diagram illustrating a method of manufacturing a through-glass via inductor with multiple cavities having magnetic material.

FIGS. 8A-8F are examples of cross-sectional schematic side views of various stages of manufacturing a through-glass via inductor with multiple cavities having magnetic material.

FIG. 9A is an example of a cross-sectional schematic top view of a through-glass via inductor with three discrete cavities.

FIG. 9B is an example of a cross-sectional schematic top view of a through-glass via inductor with interconnected cavities forming a single continuous cavity.

FIG. 10 is an example of a cross-sectional schematic side view of a through-glass via inductor with multiple cavities and magnetic coatings on metal traces of the inductor.

FIG. 11A is an isometric view illustration depicting two adjacent interferometric modulator (IMOD) display elements in a series or array of display elements of an IMOD display device.

FIG. 11B is a system block diagram illustrating an electronic device incorporating an IMOD-based display including a three element by three element array of IMOD display elements.

FIGS. 12A and 12B are schematic exploded partial perspective views of a portion of an electromechanical systems (EMS) package including an array of EMS elements and a backplate.

FIGS. 13A and 13B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

For example, the disclosed implementations described herein relate to three-dimensional (3-D) through-glass via inductors. A first cavity may be formed in the through-glass via inductor to increase the quality factor. Additionally, the cavity may be filled with magnetic material to increase the inductance. To further increase inductance, one or more second cavities may be formed outside the through-glass via (TGV) inductor. The through-glass via inductor may include at least two through-glass vias partially or completely filled with metal to form at least two metal bars. The metal bars may be connected by at least a metal trace to define an inductor.

In some implementations, each of the first cavity and the one or more second cavities may be filled with magnetic material. By surrounding the inductor with magnetic material, the volume of magnetic medium increases to improve inductance. The magnetic material may include a plurality of particles having an average diameter of less than about 20 nm. In some implementations, the particles may be coated with an insulating material, such as silicon oxide (SiOx). Such an arrangement can reduce losses due to eddy currents.

Each of the first cavity and the one or more second cavities may be blind vias that extend only partially through the glass substrate. In some implementations, the first cavity and the one or more second cavities form a continuous cavity within the glass substrate, which further increases magnetic flux coupling. In some implementations, a magnetic coating may be formed on the metal trace that effectively adds magnetic material above and/or below the inductor to further improve inductance.

Particular implementations of the subject matter described in this disclosure can be implemented to realize one or more of the following potential advantages. Compared to through-silicon via (TSV) inductors, through-glass via (TGV) inductors can achieve a higher resonant frequency and lower losses for a higher quality factor. Compared with discrete inductors, such as planar inductors, the TGV inductors may have a reduced form factor and occupy less space. Thus, the fabrication processes for the inductor may allow for co-fabrication with other EMS or MEMS devices and semiconductor devices and have a reduced cost. Moreover, the inductor as described herein may have a greater cross-sectional area for the magnetic flux path for higher inductance, a thicker magnetic core for improved linearity, thicker conductor traces for higher quality factor, and enable the use of a variety of magnetic core materials. Furthermore, the inductor as described herein can increase magnetic flux density, which can increase inductance density. The presence of a high permeability magnetic core tends to concentrate magnetic flux within the inductor windings, leading to decreased parasitic inter-device coupling.

In some implementations, the presence of additional regions of magnetic materials further increases inductance. Magnetic materials may be positioned inside of the inductor and outside of the inductor, such that the magnetic flux extending out of the inductor is confined. By confining the magnetic flux, parasitic inter-device coupling is further decreased and the increased concentration of magnetic flux within the inductor windings leads to a higher inductance density value. Thus, the inductor has a higher quality factor.

In some implementations, the magnetic materials may include a plurality of particles coated with insulating material. Such implementations of magnetic particles coated with insulating material may lower the magnetic loss tangent and reduce eddy current losses to further improve the quality factor of the inductor.

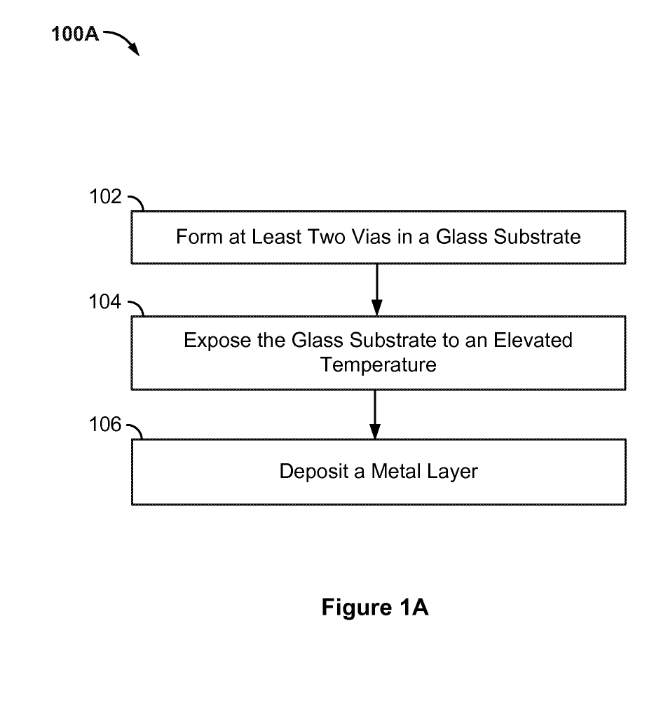

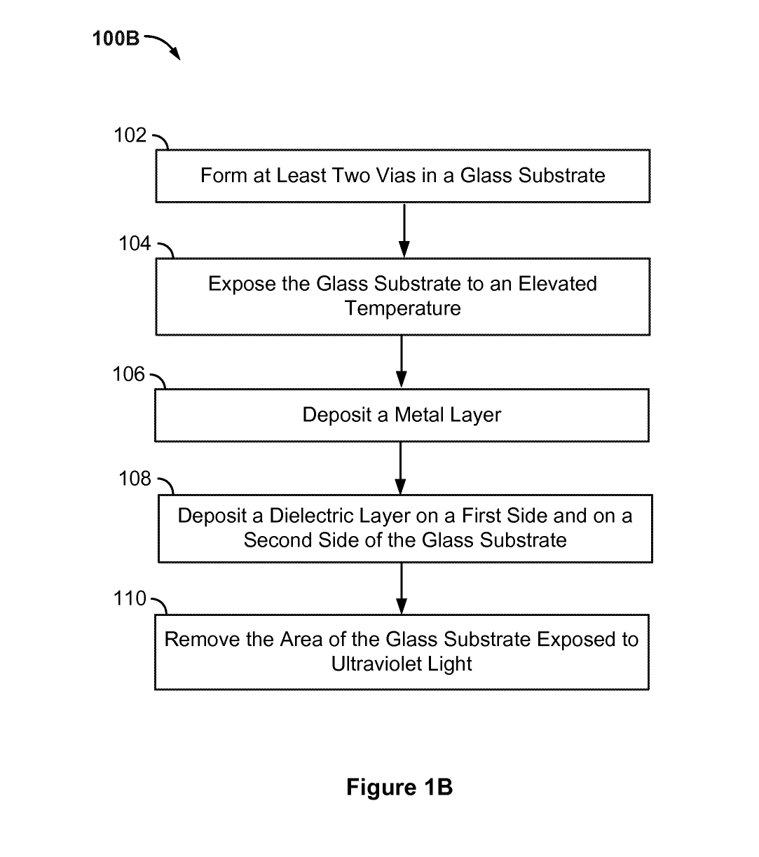

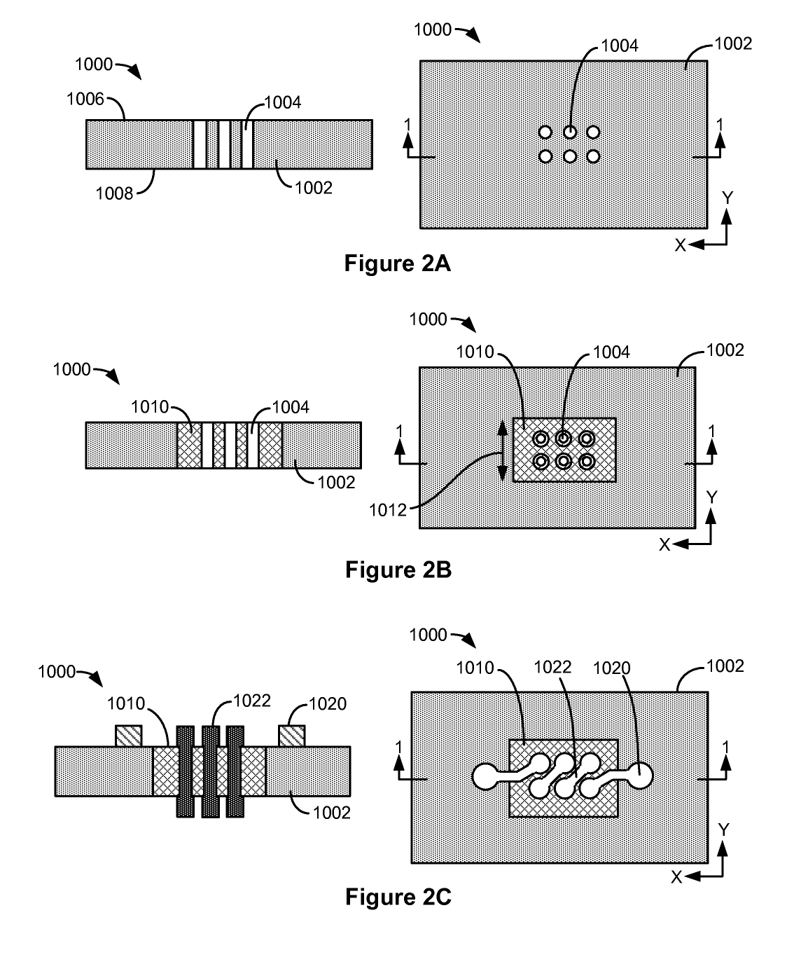

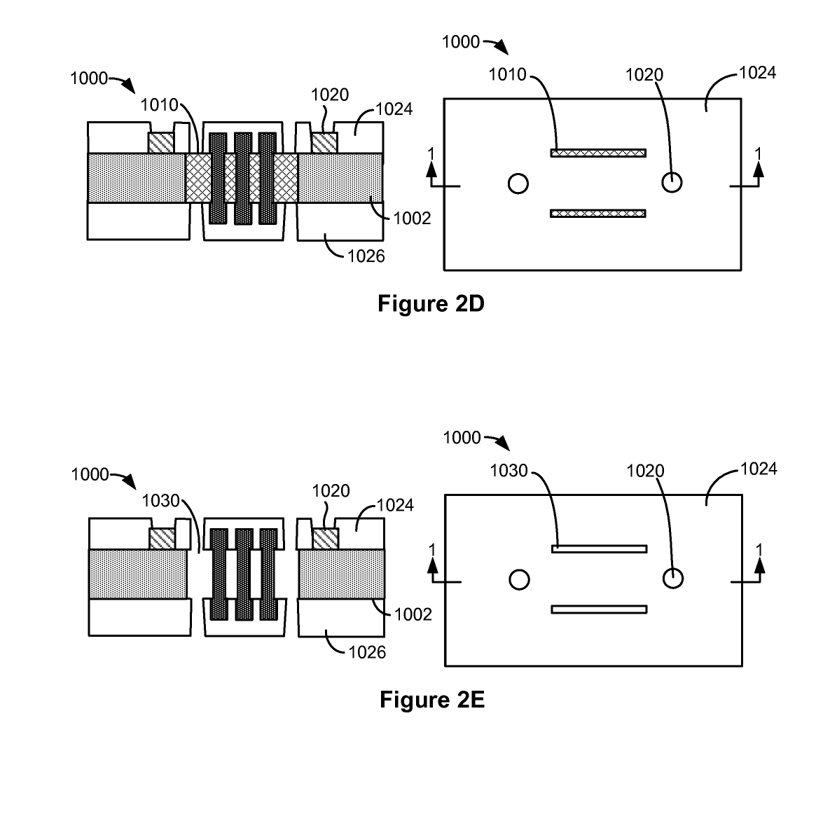

To aid in the understanding of implementations of through-glass via inductors as described herein, implementations of manufacturing processes for an inductor, accompanied by top-down and cross-sectional schematic illustrations of an inductor at various stages in the manufacturing process, are set forth below. FIG. 1A is an example of a flow diagram illustrating a manufacturing process for a through-glass via inductor. FIGS. 2A-2C are examples of schematic illustrations of a through-glass via inductor at various stages in the manufacturing process of FIG. 1A. FIG. 1B is another example of a flow diagram illustrating a manufacturing process for a through-glass via inductor. FIGS. 2A-2E are examples of schematic illustrations of a through-glass via inductor at various stages in the manufacturing process of FIG. 1B. In some implementations, the through-glass via inductor includes an air core. Each of the FIGS. 2A-2E includes an example of a cross-sectional schematic illustration of the inductor through line 1-1 in the corresponding top-down schematic illustration.

In a process 100A shown in FIG. 1A, patterning techniques, including masking as well as etching processes, may be used to define the shapes of the different components of an inductor. At block 102 of the process 100A, at least two vias are formed in a glass substrate. Glass substrates can include any suitable type of glass known in the art, including but not limited to photoglass, borosilicate glass, soda lime glass, quartz, Pyrex, or other glass material. In some implementations, the glass substrate may include a photoimageable glass. One example of photoimageable glass is APEX™ Glass, manufactured by Life Bioscience, Inc. (Albuquerque, N. Mex.), although other photoimageable glass manufacturers also can supply the requisite substrates. Photoimageable glasses are generally borosilicate-based glasses with oxide additions.

Different processes may be used to form the vias in the glass substrate. For example, a laser ablation process, a mediablasting or sandblasting process, an ultrasonic drilling process, or an etching process (such as a chemical wet etching process or a dry reactive ion etching process), or a combination of the above processes, may be used to form the vias. In some implementations, the vias may be formed by exposing a photoimageable glass where the vias are to be formed to ultraviolet (UV) light. A mask, for example, may be used to define the area of the photoimageable glass that is exposed to ultraviolet light. The photoimageable glass may then be exposed to an elevated temperature. Exposing an area of the photoimageable glass to ultraviolet light and then exposing the photoimageable glass to an elevated temperature may result in a change of the structural and/or chemical properties of the area exposed to ultraviolet light. As a result, this exposed area may have a higher etch rate than the unexposed area of the photoimageable glass, allowing the vias to be etched in the photoimageable glass using an acid (such as hydrofluoric acid (HF), ethylenediamine pyrocatechol, potassium hydroxide/isopropyl alcohol, tetramethylammonium hydroxide).

FIG. 2A shows examples of schematic illustrations of the partially fabricated inductor at this point (such as up through block 102) in the process 100A. An inductor 1000 includes a glass substrate 1002 defining at least two vias, one via of which is a via 1004. In some implementations, the photoimageable glass substrate 1002 may have a thickness in the range of about 30 micrometers (μm or microns) to about 1 millimeter (mm), such as a thickness of about 300 microns. In some implementations, the vias may have a diameter in the range of about 20 microns to about 500 microns.

In FIG. 2A, in some implementations, an upper surface 1006 and/or a lower surface 1008 of the glass substrate 1002 may be coated with a thermal ground plane (TGP) including a material such as aluminum nitride (AlN) before forming the vias in both the substrate 1002 and TGP layer(s) at block 102. For example, AlN can be sputter-deposited on one or both sides of the glass substrate 1002 before performing additional processing blocks as described herein.

Returning to FIG. 1A, an area of the glass substrate where a cavity is to be formed can be exposed to ultraviolet light. In some implementations, the area where the cavity is to be formed includes the at least two vias formed in operation 102. At block 104, the glass substrate is exposed to an elevated temperature. Exposing an area of a photoimageable glass to ultraviolet light and then exposing the photoimageable glass to an elevated temperature may result in a change of the structural and/or chemical properties of the area exposed to ultraviolet light. As a result, this exposed area may have a higher etch rate than the unexposed area of the photoimageable glass.

FIG. 2B shows examples of schematic illustrations of the partially fabricated inductor 1000 at this point (such as up through block 106) in the process 100A. The inductor 1000 includes the glass substrate 1002 defining at least two vias, one via of which is the via 1004. Area 1010 is the area of the glass substrate 1002 exposed to ultraviolet light. The area 1010 may have a width 1012 of about 100 microns to a few millimeters.

Returning to FIG. 1A, at block 106 a metal layer is deposited. In some implementations, the deposited metal layer at least partially fills the vias and forms traces connecting the vias. For example, when two vias are present, a trace may connect the metal of a first via with the metal of a second via.

In some other implementations, different metal layers may be deposited in different vias. For example, a copper paste may substantially fill one of the vias and a silver paste may substantially fill another one of the vias. Use of different metal layers may increase the conductance of the through-glass via inductor, which can therefore improve the inductor's quality factor.

In some implementations, a dry film mask may be used to define the regions of the glass substrate onto which the metal layer is deposited. In some implementations, the dry film mask may be made of a photo-sensitive polymer. In some implementations, the metal layer may be deposited using a physical vapor deposition (PVD) process, a chemical vapor deposition (CVD) process, an evaporation process, an electroplating process, an electroless plating process, or combination of such processes.

In some other implementations, the metal layer or layers may be deposited using a plating process. For example, a seed layer may first be deposited onto surfaces of the glass substrate. In some implementations, the seed layer may be deposited using a PVD process, a CVD process, an evaporation process, an atomic layer deposition (ALD) process, or an electroless plating process. In some implementations, the seed layer may include titanium (Ti), titanium nitride (TiN), ruthenium-titanium nitride (Ru—TiN), platinum (Pt), palladium (Pd), gold (Au), silver (Ag), copper (Cu), nickel (Ni), Mo, or tungsten (W). In some implementations, the seed layer may be about 25 nanometers (nm) to about 500 nm thick. After the seed layer is deposited, the metal layer may be deposited using a plating process, with the seed layer acting as a nucleation site for the plating process. The plating process may be an electroless plating process or an electroplating process. Cu, a Cu alloy, Ni, a Ni alloy, Ag, an Ag alloy, Au or aluminum (Al), for example, may be plated onto the seed layer. In some implementations, the plated metal may not be the same metal as a metal of the seed layer. In some other implementations, the plated metal may be the same metal as a metal of the seed layer.

In some implementations, a photoresist may be used to define the portions of the seed layer onto which a metal will be plated. After plating the metal, the seed layer remaining on the surfaces of the glass substrate onto which the metal was not plated may be removed. For example, the seed layer may be removed with an etching process.

FIG. 2C shows examples of schematic illustrations of the fabricated inductor 1000 at this point (such as up through block 106) in the process 100A. The inductor 1000 includes the glass substrate 1002 having the area 1010 exposed to ultraviolet light. Metal layer 1020 is disposed on the glass substrate 1002, at least partially filling the vias and forming a trace 1022 connecting the metal of different vias. In some implementations, the metal layer 1020 may include Cu, a Cu alloy, a Cu-based powder, a Cu-based paste, Ni, a Ni alloy, Ag, an Ag alloy, an Ag-based powder, an Ag-based paste, Au, an Au alloy, or Al. In some implementations, the metal layer 1020 may be about 0.5 microns to 30 microns thick. As shown in FIG. 2C, the metal layer 1020 may at least partially fill the vias, or substantially fill the vias. In other some implementations, however, the metal layer 1020 may not substantially fill the vias. The metal in metal layer 1020 may be the same for the vias in some implementations, and may be different for the vias in other implementations.

In some implementations, the fabrication of the inductor 1000 as shown in FIG. 2C is complete after performing blocks 102, 104 and 106 of FIG. 1A. Thus, portions of the glass substrate 1002 remain embedded in the inductor 1000 in such implementations. In some other implementations, as described below with reference to FIG. 1B, the inductor 1000 as shown in FIG. 2C is partially fabricated before performing additional processing blocks.

The process 100B of FIG. 1B includes blocks 102, 104 and 106 of FIG. 1A as described above. In addition, the example of FIG. 1B includes a block 108, at which a dielectric layer is deposited on a first side and on a second side of the glass substrate. In some implementations, the dielectric layers may be deposited with a lamination process. In some implementations, the dielectric layers may include a polyimide, benzocyclobutene (BCB), or a Zeon insulated film such as polyolefin.

In some implementations, after the dielectric layers are deposited, portions of the dielectric layers may be removed from the first side and/or the second side of the glass substrate to expose some of the area of the glass substrate exposed to ultraviolet light and some of the metal layer. In some implementations, the portions of the dielectric layers may be removed with a laser etching process or a photolithography process combined with a chemical etching process or a plasma chemical etching process.

FIG. 2D shows examples of schematic illustrations of the partially fabricated inductor 1000 at this point (such as up through block 108) in the process 100B. The inductor 1000 includes the glass substrate 1002 having the area 1010 exposed to ultraviolet light. The metal layer 1020 is disposed on the glass substrate 1002, at least partially filling the vias and forming traces connecting the metal of different vias. A first dielectric layer 1024 is disposed on a first side of the glass substrate 1002 and a second dielectric layer 1026 is disposed on a second side of the glass substrate 1002. In some implementations, the dielectric layers 1024 and 1026 may include a polyimide, benzocyclobutene, or a Zeon insulated film. Portions of the dielectric layers 1024 and 1026 have been removed to expose a region of the metal layer 1020 and of the area 1010 of the glass substrate 1002 exposed to ultraviolet light. In some implementations, the dielectric layers 1024 and 1026 may be about 10 microns to about 250 microns thick.

Returning to FIG. 1B, at block 110 the area of the glass substrate exposed to ultraviolet light is removed. In some implementations, the glass substrate exposed to ultraviolet light may be removed with a chemical etching process. Exposing the area of a photoimageable glass to ultraviolet light and then exposing the photoimageable glass to an elevated temperature may result in a change of the structural and/or chemical properties of the area exposed to ultraviolet light. As a result, this exposed area may have a higher etch rate than the unexposed area of the photoimageable glass.

FIG. 2E shows examples of schematic illustrations of the inductor 1000 at this point (such as up through block 110) in the process 100B. The inductor 1000 includes the glass substrate 1002 with the first dielectric layer 1024 disposed on the first side of the glass substrate 1002 and the second dielectric layer 1026 disposed on the second side of the glass substrate 1002. After the chemical etching process described above, an open region is formed. Together, the open region of the glass substrate 1002, the first dielectric layer 1024, and the second dielectric layer 1026 form a cavity 1030. The metal layer 1020 is disposed on the glass substrate 1002 and also forms bars of metal in the cavity 1030.

In some implementations, the processes 100A or 100B may include additional process operations. For example, in some implementations, the adhesion of the metal layer to the glass substrate may be insufficient. This may occur for several reasons. For example, when the metal layer is plated onto the glass substrate, the seed layer may delaminate from the glass substrate. As another example, the metal layer may not plate at all onto the surfaces of the glass substrate.

To improve the adhesion of the metal layer to the glass substrate, the processes 100A or 100B may include the additional process operation of depositing a dielectric adhesion layer on the surfaces of the glass substrate, including the surfaces defining the vias, before depositing the metal layer. In some implementations, the dielectric adhesion layer may include an oxide layer. For example, the dielectric adhesion layer may include SiO₂, Al₂O₃ (aluminum oxide), ZrO₂ (zirconium oxide), hafnium oxide (HfO₂), yttrium oxide (Y₂O₃), tantalum oxide (TaO₂), a SrO/TiO₂ (strontium oxide/titanium oxide) mixture, or SiO₂ doped with other oxides.

In some implementations, the dielectric adhesion layer may be deposited with an atomic layer deposition (ALD) process. ALD is a thin-film deposition technique performed with one or more chemical reactants, also referred to as precursors. For example, in some implementations, an Al₂O₃ dielectric adhesion layer may be deposited using trimethyl aluminum (TMA) as an aluminum precursor gas and at least one of water (H₂O) or ozone (O₃) as an oxygen precursor gas. Other suitable precursor gases are also available. For example, other suitable aluminum precursor gases include tri-isobutyl aluminum (TIBAL), tri-ethyl/methyl aluminum (TEA/TMA), and dimethylaluminum hydride (DMAH). In some implementations, the dielectric adhesion layer may be about 1 nm to 20 nm thick, or about 5 nm thick. In some implementations, depositing a dielectric adhesion layer of about 5 nm thick may be achieved with about 100 ALD process cycles.

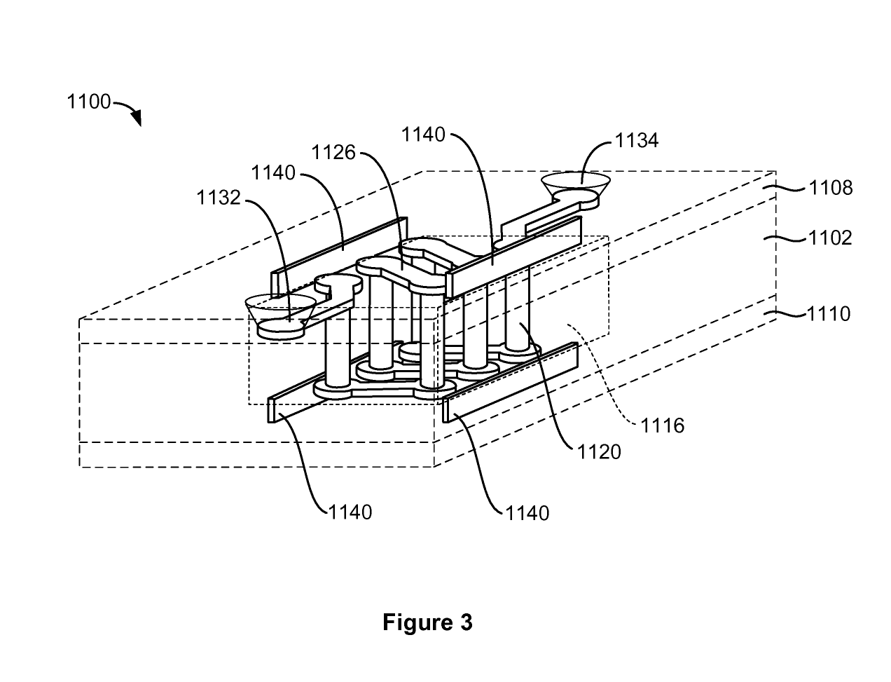

FIG. 3 is an example of a perspective view of an isometric projection of a through-glass via inductor. In some implementations, the through-glass via inductor includes an air core. An inductor 1100 includes a glass substrate 1102 having a first dielectric layer 1108 disposed on a first surface of the glass substrate 1102 and a second dielectric layer 1110 disposed on a second surface of the glass substrate 1102. In some implementations, the glass substrate 1102 includes a photoimageable glass. In some implementations, the glass substrate 1102 may be about 30 microns to about 1 mm thick, or about 500 microns thick. In some implementations, the dielectric layers 1108 and 1110 may be about 10 microns to about 250 microns thick. Together, an open region defined in the glass substrate 1102, the first dielectric layer 1108, and the second dielectric layer 1110 define a cavity 1116. The cavity 1116 may have a width of about 100 microns to about a few millimeters.

The cavity 1116 includes at least two metal bars, one of which is a metal bar 1120. The inductor 1100 includes six metal bars 1120. A first end of each metal bar 1120 is proximate the first dielectric layer 1108 and a second end of each metal bar is proximate the second dielectric layer 1110. In some implementations, at least two metal bars are hollow metal bars, and in some other implementations, at least two metal bars are solid metal bars. In some implementations, the metal bars may include Cu, a Cu alloy, a Cu-based powder, a Cu-based paste, Ni, a Ni alloy, Ag, an Ag alloy, an Ag-based powder, an Ag-based paste, Au, an Au alloy, or Al. In some implementations, the metal bars may have a cross-sectional dimension of about 30 microns to about 400 microns. For example, when the metal bars are cylinders, the metal bars may have a diameter of about 30 microns to 400 microns. Metal traces, one of which is a trace 1126, connect a first metal bar with a second metal bar. In some implementations, the metal traces may include Cu, a Cu alloy, a Cu-based powder, a Cu-based paste, Ni, a Ni alloy, Ag, an Ag alloy, an Ag-based powder, an Ag-based paste, Au, an Au alloy, or Al. In some implementations, the metal traces may be about 0.5 microns to about 20 microns thick. Points 1132 and 1134 provide points where metal traces of the inductor 1100 may be connected to a current source. Channels 1140 in the first dielectric layer 1108 and the second dielectric layer 1110 provide a region where the glass substrate 1102 can be etched to form the cavity 1116.

The manufacturing processes 100A and 100B shown in FIGS. 1A and 1B may be used to fabricate a through-glass via inductor having a number of different configurations. For example, an inductor having any number of turns, such as a half turn, 1 turn, 3.5 turns, 10 turns, 10.5 turns, 25 turns and 50 turns, may be fabricated with the manufacturing processes 100A and 100B.

In some implementations, the manufacturing processes 100A and 100B may include additional process operations to form a magnetic core for the through-glass via inductor. Thus, an inductor may include a magnetic core disposed in the air core. Core materials with a higher permeability than air can increase the magnetic field and confine it closely to the inductor. In some implementations, a magnetic core may increase the inductance of a through-glass via inductor.

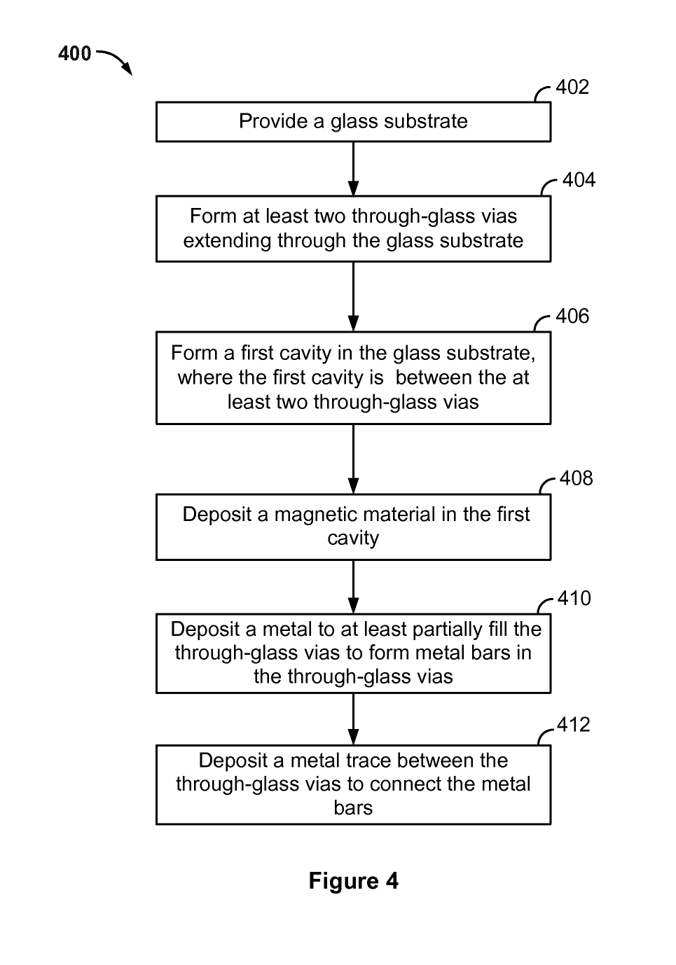

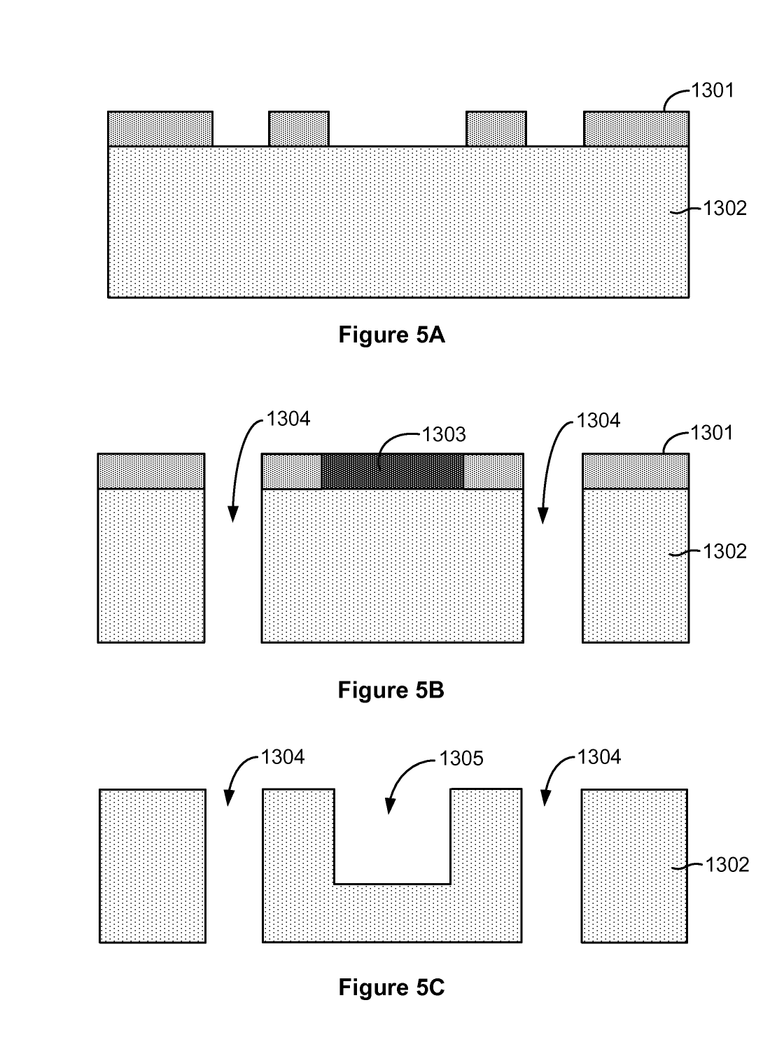

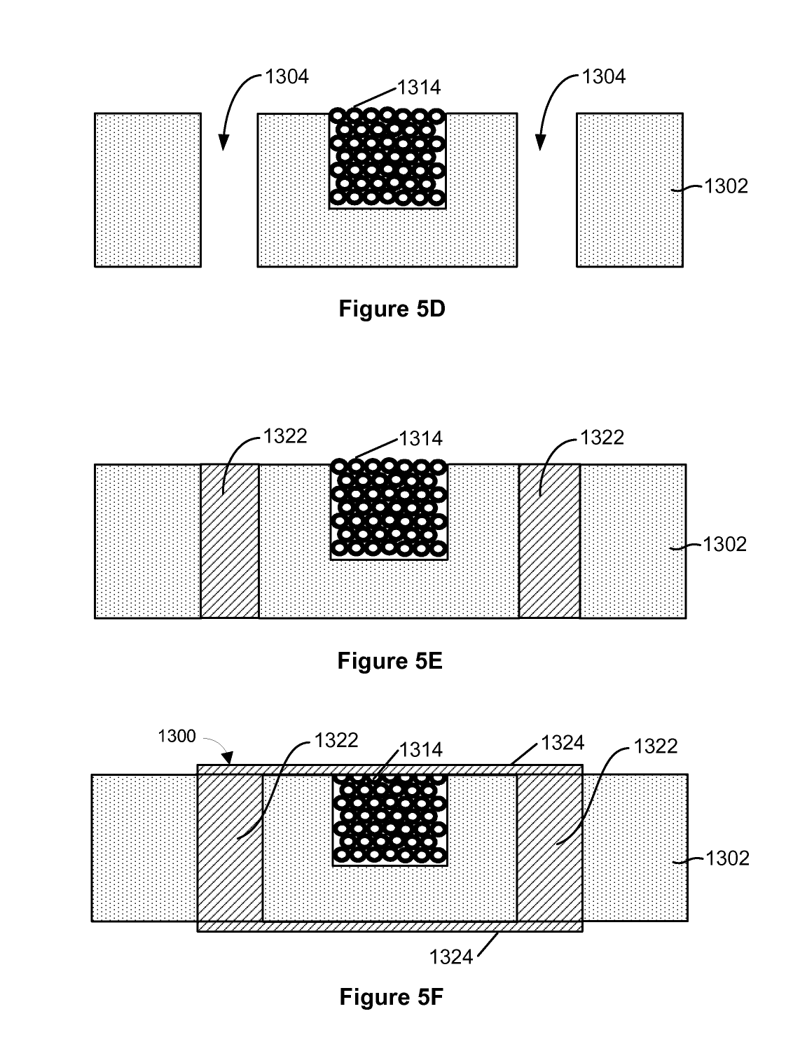

Another implementation of a manufacturing process for a through-glass via inductor is set forth below with respect to FIGS. 4 and 5A-5F. FIG. 4 is an example of a flow diagram illustrating a method of manufacturing a through-glass via inductor with a cavity having magnetic material. FIGS. 5A-5F are examples of cross-sectional schematic side views of various stages of manufacturing a through-glass via inductor with a cavity having magnetic material.

The process 400 can begin at block 402 where a glass substrate is provided. Glass substrates can include any suitable type of glass known in the art, including but not limited to photoglass, borosilicate glass, soda lime glass, quartz, Pyrex, or other glass material. In some implementations, the glass substrate may be a photoimageable glass. The photoimageable glass substrate may have a thickness between about 30 microns and about 1 millimeter, such as about 300 microns.

FIG. 5A shows an example of a cross-sectional schematic side view of the partially fabricated through-glass via inductor at this point (such as up through block 402) in the process 400. A mask 1301 may be formed on the surface of the glass substrate 1302. The mask 1301 may be formed of a polymeric photoresist material. In some implementations, the mask 1301 may define the area of the photoimageable glass that is to be exposed to ultraviolet light. As illustrated in FIG. 5A, the mask 1301 has a plurality of openings to expose the glass substrate 1302 to form cavities and vias. In some implementations, the mask 1301 may be used to pattern the area of the glass that is to be laser ablated, media blasted or sandblasted, glass formed, drilled, or etched.

The process 400 can continue at block 404 where at least two through-glass vias are formed extending through the glass substrate. Different processes, including a laser ablation process, a mediablasting or sandblasting process, a glass forming process, an ultrasonic drilling process, an etching process, or a photoimageable glass processing process, may be used to form the at least two vias in the glass substrate. A photoimageable glass processing process may include exposing areas defined by the mask to ultraviolet light, exposing the glass substrate to an elevated temperature, and removing the exposed portions of the glass substrate by subjecting such portions to a wet etch (such as HF acid, ethylenediamine pyrocatechol, potassium hydroxide/isopropyl alcohol, tetramethylammonium hydroxide). A laser ablation process may include using a laser to drill through the glass substrate partially from the top, and subsequently using the laser to drill through a remaining portion to form a via from the bottom.

FIG. 5B shows an example of a cross-sectional schematic side view of the partially fabricated through-glass via inductor at this point (such as up through block 404) in the process 400. An additional mask 1303 may be placed over the glass substrate 1302 where a blind via is to be formed. At least two vias 1304 are formed extending through the glass substrate 1302. The vias 1304 may be formed based on the pattern of the masks 1301 and 1303 disposed on the glass substrate 1302. The vias 1304 define sidewalls within the glass substrate 1302 and may be substantially perpendicular to the top and bottom surfaces of the glass substrate 1302. In some implementations, the vias 1304 may have a diameter between about 20 microns and about 500 microns, and a depth extending about the thickness of the glass substrate 1302.

Returning to FIG. 4, the process 400 continues at block 406 where a first cavity is formed in the glass substrate that is between the at least two through-glass vias. In some implementations, the first cavity is a via that extends only partially through the glass substrate. Such a via may be referred to as a “blind” via.

In some implementations, the blind via and the at least two through-glass vias may be formed at different times. For example, at block 402 in FIG. 4, the mask over the glass substrate may define both areas where the blind via and the at least two through-glass vias are to be formed. This is illustrated in FIG. 5A, in which the area where the blind via is to be formed can be exposed to ultraviolet light and exposed to an elevated temperature. This results in a change of the structural and/or chemical properties of the area exposed to ultraviolet light, such that the exposed area may have a higher etch rate than the unexposed area of the glass substrate. Another mask 1303 is placed over the glass substrate where the blind via is to be formed. At block 404 in FIG. 4, the at least two through-glass vias are formed by etching. This is illustrated in FIG. 5B, where that the two through-glass vias 1304 are formed while the area covered by the mask 1303 is not etched during formation of the at least two through-glass vias 1304. Thus, upon removal of the mask 1303 where the blind via is to be formed, the blind via 1305 may be subsequent formed by an appropriate removal technique, such as etching, as illustrated in FIG. 5C. In some implementations, the blind via 1304 and the through-glass vias 1304 may be formed by different techniques, using a combination of etch-based and drill-based processes.

In some implementations, the blind via and the at least two through-glass vias may be formed concomitantly. In such implementations, a single mask may be sufficient for defining the through-glass vias and the blind via, without the need for another mask 1303 as shown in FIG. 5B. For example, at block 402 in FIG. 4, a mask over the glass substrate may provide openings where the at least two through-glass vias are to be formed, and the mask also may provide a plurality of smaller openings where the blind via is to be formed. The openings in the mask for the at least two through-glass vias and the plurality of smaller openings in the mask for the blind via provide areas that may be exposed to ultraviolet light and subsequently subjected to an elevated temperature. The smaller openings in the mask for the blind via provide for a slower etch rate compared to the larger openings in the mask for the at least two through glass vias. While the at least two through-glass vias are formed by etching, the blind via is also formed at the same time. Other process parameters may allow for differentiated etching for the through-glass vias and the blind via. Diameters of the through-glass vias (such as between about 20 μm and about 100 μm) may be substantially smaller than a diameter of the blind via (such as between about 100 μm and about 1 mm), which provides faster etching of the through-glass vias while leaving a blind via that only partially etches through the glass substrate in a timed etch. Thus, the formation of the blind via and the at least two through-glass vias in blocks 404 and 406 can occur simultaneously. By subjecting the exposed glass substrate to a timed etch, the blind via and the at least two through-glass vias may be formed in a single step.

FIG. 5C shows an example of a cross-sectional schematic side view of the partially fabricated through-glass via inductor at this point (such as up through block 406) in the process 400. A first cavity 1305 may be between the at least two through-glass vias 1304 that extends only partially through the glass substrate 1302. The first cavity 1305 may include sidewalls and a bottom surface defined within the glass substrate 1302. The first cavity 1305 may be between about 100 μm and about 1 mm in diameter, and may be between about 10 μm and about 1 mm in depth.

Returning to FIG. 4, the process 400 continues in block 408 where a magnetic material is deposited in the first cavity. The magnetic material may be deposited in the first cavity using any suitable techniques known in the art, such as inkjet printing, screen printing, laser printing, mechanical filling, photolithography and etching, spin-on processes, electroplating, electroless plating, chemical vapor deposition (CVD), physical vapor deposition (PVD), or atomic layer deposition (ALD). In some implementations, the magnetic material can include a plurality of particles. The particles may be deposited in the first cavity by submerging the partially fabricated through-glass via inductor in a solution containing the plurality of particles. As a result, the plurality the particles may become trapped inside the first cavity to provide magnetic material in the first cavity.

FIG. 5D shows an example of a cross-sectional schematic side view of the partially fabricated through-glass via inductor at this point (such as up through block 408) in the process 400. In some implementations, the magnetic material 1314 may include a bulk ferromagnetic or ferrimagnetic material having a ferromagnetic or ferrimagnetic core. In some implementations, the magnetic material 1314 may include a plurality of particles, where the average diameter of each of the particles can be less than about 20 nm. The particles may be made of ferromagnetic or ferrimagnetic materials, such as iron (Fe), Ni, cobalt (Co), alloys of Fe, and Ni and Co. In some implementations, the magnetic material 1314 may include ferrites, which can include ceramic iron oxides. Ferrites may reduce eddy current losses and exhibit low losses at high frequencies.

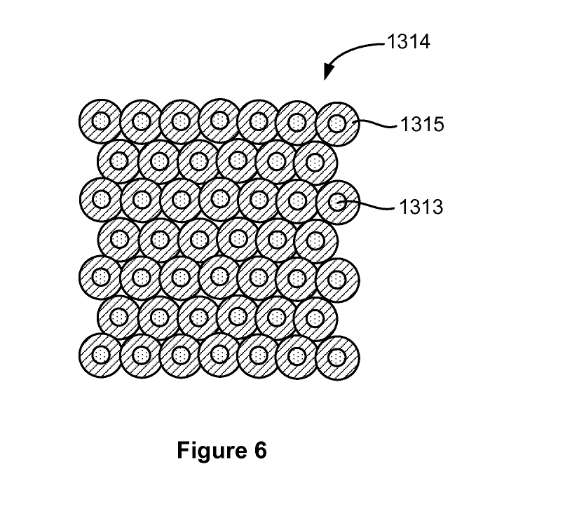

FIG. 6 is an example illustrating a magnified view of magnetic material. The magnetic material 1314 may include a plurality of particles 1313 each having a coating 1315. The average size of the particles 1313 may be between about 1 nm and about 20 nm in diameter, such as about 10 nm. The average thickness of the coating 1315 may be between about 1 nm and about 200 nm, such as between about 5 nm and about 100 nm, or such as about 50 nm. Thus, the thickness of the coating 1315 may be larger than the size of the particles 1313. The spacing between particles 1313 may be about twice the size of or greater than the thickness of the coating 1315.

In the example in FIG. 6, the coating 1315 may include an insulating material. The insulating material can include, for example, silicon oxide. In some implementations, the insulating material can be graphene, surfactants, polymers, or other passivation material. The insulating coating 1315 may prevent shorting between particles 1313 that may be conducting, and between particles 1313 and neighboring structures. The insulating coating 1315 also may eliminate the need to form additional insulating layers or a polymer matrix with the magnetic material 1314. The particles 1313 may be coated with the coating 1315 including insulating material using any suitable technique known in the art. For example, the particles 1313 may be immersed in a solution containing tetraethyl orthosilicate (TEOS), which can readily convert into silicon oxide upon the addition of water. In some implementations, the thickness of the coating 1315 may be dependent on the concentration of TEOS in solution, duration of exposure to the solution, and other processing conditions. For example, a higher concentration of TEOS and/or a longer exposure time may increase the thickness of the coating 1315.

Unlike bulk conducting materials, the magnetic material 1314 is composed of a plurality of discrete particles 1314 with an insulating coating 1315 to space apart each of the particles 1313. Such an arrangement minimizes the formation of eddy currents flowing within the magnetic material 1314 produced from an electric field. The formation of eddy currents can degrade the performance of an inductor by increasing the inductance loss. Thus, the magnetic material 1314 as illustrated in FIG. 6 can improve the quality factor of the inductor. In some implementations, the use of a coating 1315 made of an inorganic insulating material reduces the loss tangent of an inductor. The loss tangent is a parameter of a dielectric material that quantifies the inherent dissipation of electromagnetic energy. A dielectric material such as silicon oxide has a lower loss tangent compared to an organic material. Therefore, the use of an inorganic insulating material for a coating 1315 to space apart particles 1313 for the magnetic material 1314 can improve inductance loss and loss tangent for an inductor.

Returning to FIG. 4, the process 400 continues in block 410 where a metal is deposited to at least partially fill the through-glass vias to form metal bars in the through-glass vias. In some implementations, the metal is deposited to substantially fill the through-glass vias. In some implementations, a dry film mask may be used to define the regions of the glass substrate onto which the metal is deposited. In some implementations, the dry film mask may be a photo-sensitive polymer. In some implementations, the metal may be deposited using a PVD or CVD process. In some other implementations, the metal may be deposited using a plating process, such as electroplating or electroless plating. A seed layer may be deposited on the surfaces or sidewall surfaces of the glass substrate, from which a bulk layer of metal may be plated upon using an electroplating or electroless plating process. In some implementations, different metals may be deposited in different vias. For example, a copper paste may at least partially fill one of the vias and a silver paste may at least partially fill another one of the vias. Use of different metal layers may increase the conductance of the through-glass via inductor, which can therefore improve the inductor's quality factor.

FIG. 5E shows an example of a cross-sectional schematic side view of the partially fabricated through-glass via inductor at this point (such as up through block 410) in the process 400. The metal bars 1322 may include an electrically conductive material, such as Cu, a Cu alloy, a Cu-based powder, a Cu-based paste, Ag, an Ag alloy, an Ag-based powder, an Ag-based paste, Ni, a Ni alloy, Au, an Au alloy, or Al. Upon deposition, excess metal from the metal bars 1322 may be planarized using techniques such as etching, vaporization with a laser, or chemical mechanical polishing (CMP). The thickness of the metal bars 1322 may be about the thickness of the glass substrate 1302. The dimensions of the metal bars 1322 may be between about 30 microns and about 400 microns. For example, when the metal bars 1322 are cylinders, the diameter of the metal bars 1322 may be between about 30 microns and about 400 microns.

Returning to FIG. 4, the process 400 continues in block 412 where a metal trace is deposited between the through-glass vias to connect the metal bars. For example, when two through-glass vias are present, the metal trace may connect the two through-glass vias. A dry film mask may be used to define the regions of the glass substrate onto which the metal trace is to be deposited. In some implementations, the metal trace may be deposited using PVD, CVD, ALD, an electroless plating process, an electroplating process, or a combination of such processes.

FIG. 5F shows an example of a cross-sectional schematic side view of the partially fabricated through-glass via inductor at this point (such as up through block 412) in the process 400. Metal traces 1324 may be disposed on the metal bars 1322 and connecting the metal bars 1322. The metal traces 1324 may be formed of the same material as the metal bars 1322, including Cu, Cu alloy, Ni, Ni alloy, Ag, an Ag alloy, Au, Au alloy, or Al. The metal traces 1324 may also be formed of different material than the metal bars 1322. In some implementations, the thickness of the metal traces 1324 may be between about 0.5 microns and about 30 microns.

Connecting the metal bars 1322 with the metal traces 1324 may form a three-dimensional through-glass via inductor 1300. The metal bars 1322 and the metal traces 1324 may be substantially perpendicular to one another. The metal traces 1324 may form on the top and bottom surfaces of the metal bars 1322. Though not shown in the cross-sectional side view of the example in FIG. 5F, a bottom metal trace may connect a first metal bar and a second metal bar, and the top metal trace may connect a second metal bar and third metal bar. By connecting multiple metal bars 1322 with multiple metal traces 1324, a through-glass via inductor 1300 with a plurality of turns or “windings” may be formed. The through-glass via inductor 1300 may include any number of turns, including a half turn, 1 turn, 3.5 turns, 10 turns, 10.5 turns, 25 turns, and 50 turns. Parts of the metal traces 1324 may be connected to a current source to pass a current through the through-glass via inductor 1300. The current may forms a loop current to generate a magnetic field in the through-glass via inductor 1300. The inductance of the through-glass via inductor 1300 may be increased using a magnetic material 1314 disposed within the inductor 1300 due at least in part to a higher magnetic permeability. In addition, since thickness or length of the metal bars 1322 may impact the inductance of the through-glass via inductor 1300, inductance may be increased using a relatively thick glass substrate 1302.

The through-glass via inductor 1300 formed within the glass substrate 1302 utilizes a high-resistance substrate that produces less losses and a higher resonant frequency than conventional silicon substrates. Moreover, the through-glass via inductor 1300 may be three-dimensional, in which signals pass substantially vertically through vias 1304 such that mutual inductance does not interfere with neighboring components disposed above or below the through-glass via inductor 1300.

It is understood that the formation of the through-glass via inductor 1300 may include further processing steps, such as formation of dielectric layers on a first side and a second side of the glass substrate 1302, formation of dielectric adhesion layers, etc. In some implementations, the through-glass via inductor 1300 may be embedded in various applications, such as a semiconductor package, integrated circuit, interposer, etc.

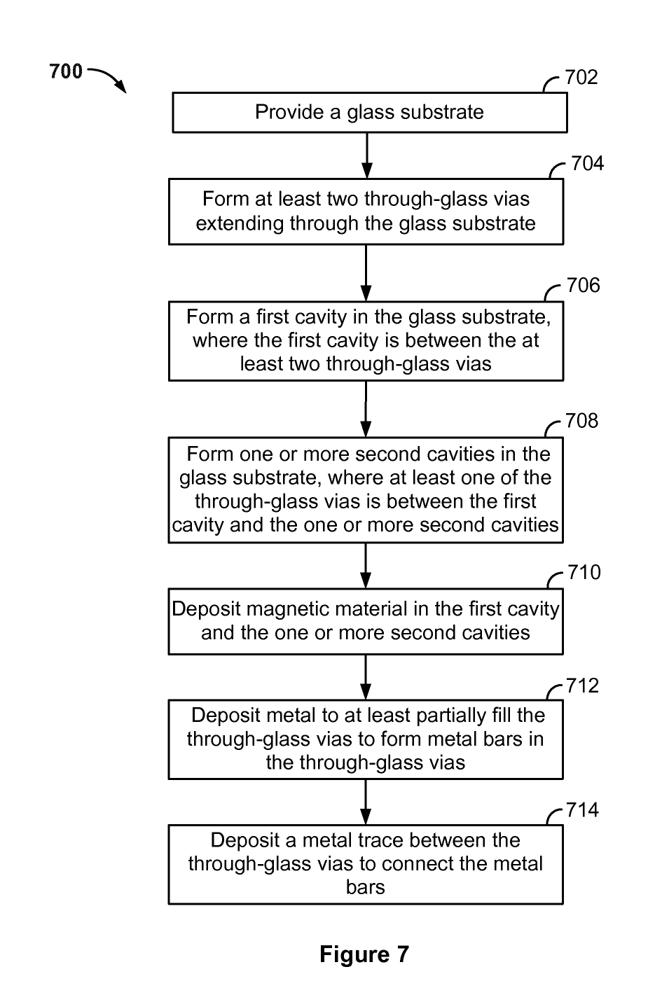

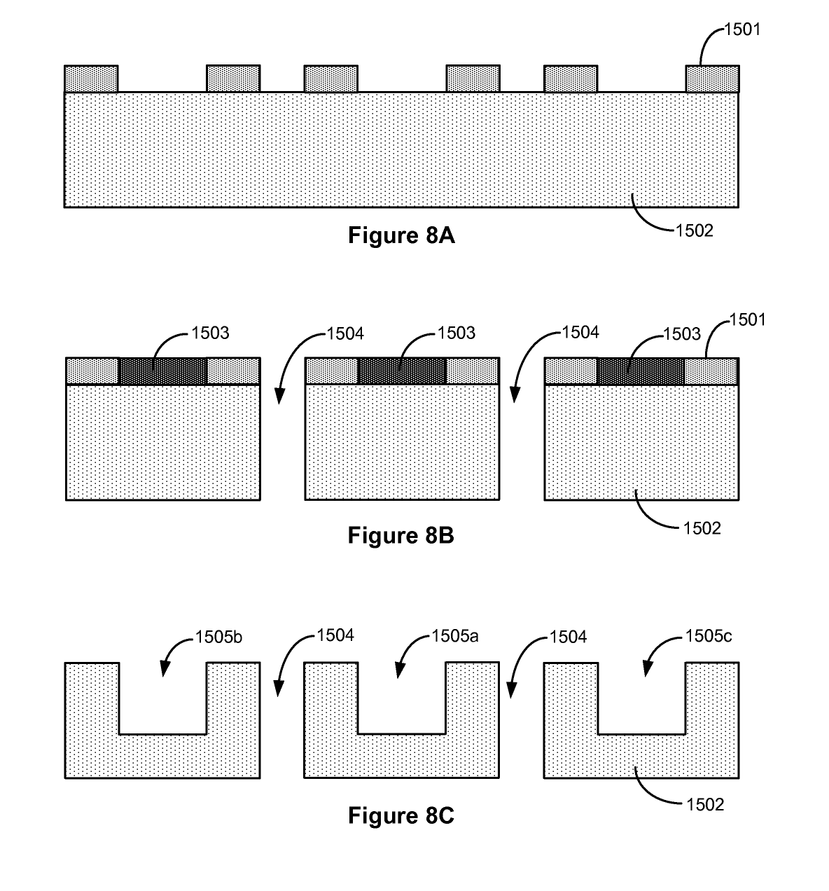

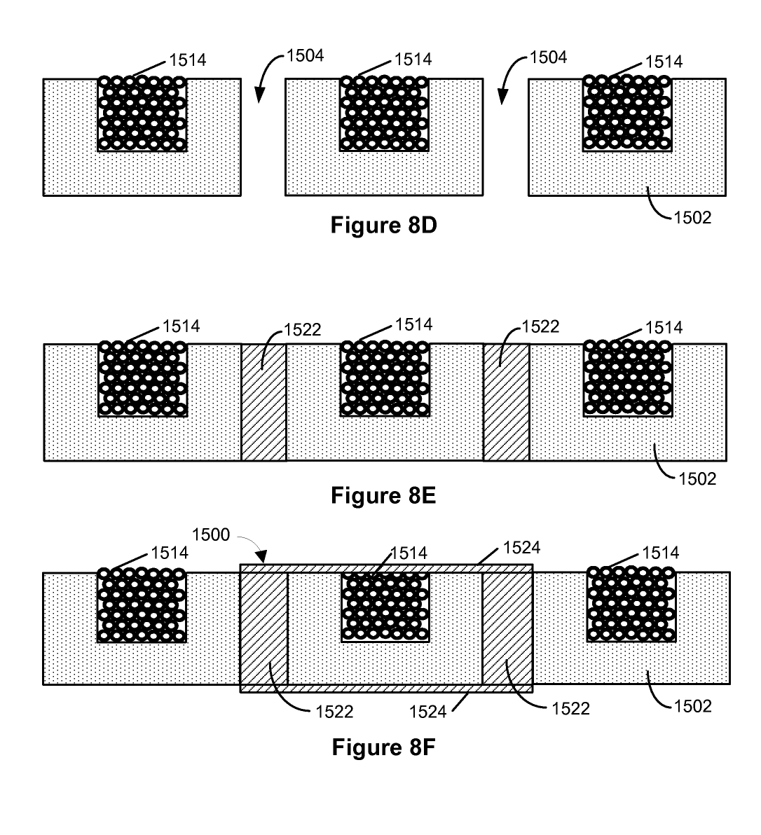

Another implementation of a manufacturing process for a through-glass via inductor is set forth below with respect to FIGS. 7 and 8A-8F. FIG. 7 is an example of a flow diagram illustrating a method of manufacturing a through-glass via inductor with multiple cavities having magnetic material. FIGS. 8A-8F are examples of cross-sectional schematic side views of various stages of manufacturing a through-glass via inductor with multiple cavities having magnetic material.

The process 700 can begin at block 702 where a glass substrate is provided. Glass substrates can include any suitable type of glass known in the art, including but not limited to photoglass, borosilicate glass, soda lime glass, quartz, Pyrex, or other glass material. In some implementations, the glass substrate may be a photoimageable glass. The photoimageable glass substrate may have a thickness between about 30 microns and about 1 millimeter, such as about 300 microns.

FIG. 8A shows an example of a cross-sectional schematic side view of the partially fabricated through-glass via inductor at this point (such as up through block 702) in the process 700. A mask 1501 may be formed on the surface of the glass substrate 1502. The mask 1501 may be formed of a polymeric photoresist material. In some implementations, the mask 1501 may define the area of the photoimageable glass that is to be exposed to ultraviolet light. As illustrated in FIG. 8A, the mask 1501 has a plurality of openings to expose the glass substrate 1502 to form multiple cavities and vias. In some implementations, the mask 1501 may be used to pattern the area of the glass that is to be laser ablated, media blasted or sandblasted, glass formed, drilled, or etched.

The process 700 can continue at block 704 where at least two through-glass vias are formed extending through a glass substrate. Different processes, including a laser ablation process, a mediablasting or sandblasting process, an ultrasonic drilling process, an etching process, or a photoimageable glass processing process, may be used to form the at least two vias in the glass substrate. A photoimageable glass processing process may include exposing areas defined by the mask to ultraviolet light, exposing the glass substrate to an elevated temperature, and removing the exposed portions of the glass substrate by subjecting such portions to a wet etch (such as HF acid, ethylenediamine pyrocatechol, potassium hydroxide/isopropyl alcohol, tetramethylammonium hydroxide). A laser ablation process may include using a laser to drill through the glass substrate partially from the top, and subsequently using the laser to drill through a remaining portion to form a via from the bottom.

FIG. 8B shows an example of a cross-sectional schematic side view of the partially fabricated through-glass via inductor at this point (such as up through block 704) in the process 700. An additional mask 1503 may be placed over the glass substrate 1502 where blind vias are to be formed. At least two vias 1504 are formed extending through the glass substrate 1502. The vias 1504 are formed where there is no mask 1501 and 1503 disposed on the glass substrate 1502. The vias 1504 define sidewalls within the glass substrate 1502 and may be substantially perpendicular to the top and bottom surfaces of the glass substrate 1502. In some implementations, the vias 1504 may have a diameter between about 20 microns and about 500 microns, and a depth extending about the thickness of the glass substrate 1502.

Returning to FIG. 7, the process 700 continues at block 706 where a first cavity is formed in the glass substrate that is between the at least two through-glass vias. The first cavity may be a blind via that extends only partially through the glass substrate. The first cavity may be between the at least two through-glass vias. The process 700 further continues at block 708, where one or more second cavities are formed in the glass substrate. At least one of the through-glass vias may be between the first cavity and the one or more second cavities. In some implementations, the one or more second cavities also may be blind vias that extend only partially through the glass substrate.

In some implementations, the first cavity and the one or more second cavities may be formed at the same time. In such implementations, a single mask may be sufficient to define the first cavity and the one or more second cavities, without the use of the additional mask 1503 as illustrated in FIG. 8B. In some other implementations, the first cavity and the one or more second cavities may be formed at different times, such as sequentially.

In some implementations, each of the blind vias and the at least two through-glass vias may be formed at different times, in a similar manner discussed earlier herein with respect to block 406 in FIG. 4. In some other implementations, each of the blind vias and the at least two through-glass vias may be formed concomitantly, also in a similar manner discussed earlier herein with respect to block 406 in FIG. 4.

FIG. 8C shows an example of a cross-sectional schematic side view of the partially fabricated through-glass via inductor at this point (such as up through blocks 706 and 708) in the process 700. A first cavity 1505a may be formed between the at least between the at least two through-glass vias 1504 and extends only partially through the glass substrate 1502. A second cavity 1505b and a third cavity 1505c also may be formed in the glass substrate 1502 and extending only partially through the glass substrate 1502. The at least two through-glass vias may be between the second cavity 1505b and the third cavity 1505c. Each of the cavities 1505a, 1505b, and 1505c may be between about 50 μm and about 1 mm in diameter, and may be between about 20 μm and about 1 mm in depth.

Returning to FIG. 7, the process 700 continues in block 710 where a magnetic material is deposited in the first cavity and in the one or more second cavities. The magnetic material may be deposited in the first cavity using any suitable techniques known in the art, such as inkjet printing, screen printing, laser printing, spin-on processes, electroplating, electroless plating, chemical vapor deposition (CVD), physical vapor deposition (PVD), or atomic layer deposition (ALD). In some implementations, the magnetic material can include a plurality of particles. The particles may be deposited in each of the cavities by submerging the partially fabricated through-glass via inductor in a solution containing the plurality of particles. The plurality the particles may become trapped inside the cavities to provide magnetic material in each of the cavities.

FIG. 8D shows an example of a cross-sectional schematic side view of the partially fabricated through-glass via inductor at this point (such as up through block 710) in the process 700. In some implementations, magnetic material 1514 may include a bulk ferromagnetic or ferrimagnetic material having a ferromagnetic or ferrimagnetic core. In some implementations, magnetic material 1514 may include a plurality of particles, where the average diameter of each of the particles can be less than about 20 nm. The particles may be made of ferromagnetic or ferrimagnetic materials, such as iron (Fe), Ni, cobalt (Co), alloys of Fe, and Ni and Co. In some implementations, the magnetic material 1514 may include ferrites, which can include ceramic iron oxides. Ferrites may reduce eddy current losses and exhibit low losses at high frequencies.

Returning to FIG. 7, the process 700 continues in block 712 where a metal is deposited to at least partially fill the through-glass vias to form metal bars in the through-glass vias. The metal bars may be formed using techniques known in the art or as discussed earlier herein.

FIG. 8E shows an example of a cross-sectional schematic side view of the partially fabricated through-glass via inductor at this point (such as up through block 712) in the process 700. The metal bars 1522 may include an electrically conductive material, such as Cu, a Cu alloy, a Cu-based powder, a Cu-based paste, Ni, a Ni alloy, Ag, an Ag alloy, an Ag-based powder, an Ag-based paste, Au, an Au alloy, or Al. After deposition, excess metal from the metal bars 1522 may be planarized using techniques such as etching, vaporization with a laser, or CMP. The thickness of the metal bars 1522 may be about the thickness of the glass substrate 1502. The dimensions of the metal bars 1522 may be between about 30 microns and about 400 microns. For example, when the metal bars 1522 are cylinders, the diameter of the metal bars 1522 may be between about 30 microns and about 400 microns.

Returning to FIG. 7, the process 700 continues in block 714 where a metal trace is deposited between the through-glass vias to connect the metal bars. The metal trace may be formed to connect the metal bars using techniques known in the art or as discussed earlier herein.

FIG. 8F shows an example of a cross-sectional schematic side view of the partially fabricated through-glass via inductor at this point (such as up through block 714) in the process 400. Metal traces 1524 may be disposed on the metal bars 1522 and connecting the metal bars 1522. The metal traces 1524 may be formed of the same material as the metal bars 1522, including Cu, a Cu alloy, Ni, a Ni alloy, Ag, an Ag alloy, Au, an Au alloy, or Al. The metal traces 1524 may also be formed of different material than the metal bars 1522. In some implementations, the thickness of the metal traces 1524 may be between about 0.5 microns and about 30 microns.

Connecting the metal traces 1524 with the metal bars 1522 may form a three-dimensional through-glass via inductor 1500, which can be similar to the through-glass via inductor 1300 in FIG. 5F. By connecting multiple metal bars 1522 with multiple metal traces, a through-glass via inductor 1500 with a plurality of turns or windings may be formed. The second cavity 1505b and the third cavity 1505c may be positioned outside the through-glass via inductor 1500 and the first cavity 1505a may be positioned inside the through-glass via inductor 1500. Put another way, the through-glass via inductor 1500 may surround the first cavity 1505a while the through-glass via 1500 may be between the second cavity 1505b and the third cavity 1505c. Magnetic material 1514 within the second cavity 1505b and the third cavity 1505c provide additional closed-loop magnetic fields inside and outside the through-glass via inductor 1500. Furthermore, magnetic material 1514 within the second cavity 1505b and the third cavity 1505c confines the magnetic flux coming from inside the through-glass via inductor 1500. Such an arrangement increases the inductance density, and therefore increases the inductor value. For example, the inductance density can increase by a factor between about 1.0 and about 1000 times, such as 1.2, 10, 50, 400 or 800 times. Thus, the through-glass via inductor 1500 can have an increased quality value. In addition, containing and confining the magnetic flux also reduces stray magnetic flux with other sensitive electrical components and can decrease parasitic inter-device coupling with any neighboring structures.

The through-glass via inductor 1500 formed within the glass substrate 1502 utilizes a high-resistance substrate that produces less losses and a higher resonant frequency than conventional silicon substrates. Moreover, the through-glass via inductor 1500 may be three-dimensional, in which signals pass substantially vertically through vias 1504 such that mutual inductance does not interfere with neighboring components disposed above or below the through-glass via inductor 1500.

It is understood that the formation of the through-glass via inductor 1500 may include further processing steps, such as formation of dielectric layers on a first side and a second side of the glass substrate 1502, formation of dielectric adhesion layers, etc. In some implementations, the through-glass via inductor 1500 may be embedded in various applications, such as a semiconductor package, integrated circuit, interposer, etc.

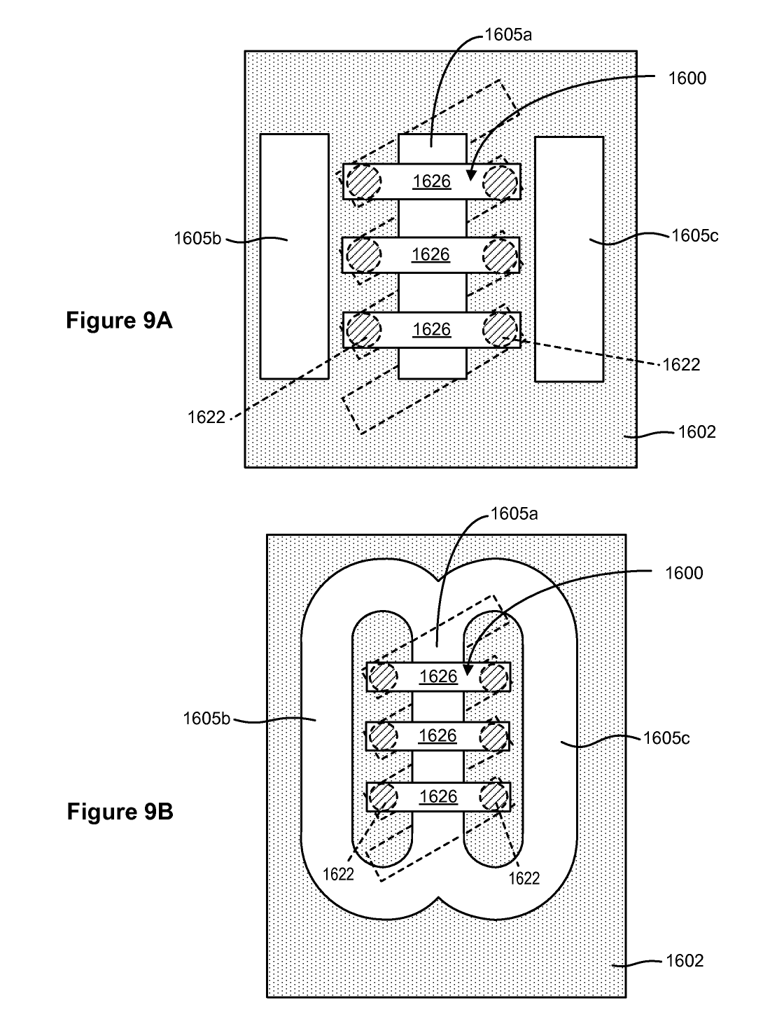

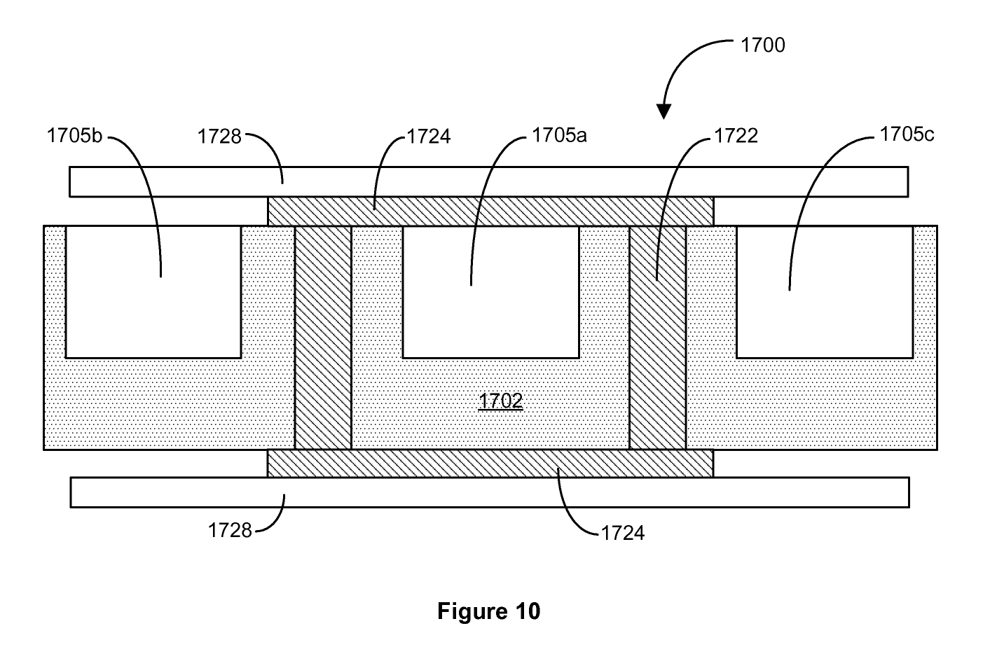

FIG. 9A is an example of a cross-sectional schematic top view of a through-glass via inductor with three discrete cavities. A first cavity 1605a, a second cavity 1605b and a third cavity 1605c may be formed in the glass substrate 1602 and extending only partially through the glass substrate 1602. Each of the cavities 1605a, 1605b and 1605c may be separate and discrete without connecting with one another. A plurality of metal bars 1622 may be formed in the glass substrate 1602. As illustrated in the example in FIG. 9A, three of six metal bars 1622 may be spaced apart and collinear with one another proximate one side of the first cavity 1605a, and another three of six metal bars 1622 may be spaced apart and collinear with one another proximate the opposite side of the first cavity 1605a. The metal bars 1622 may be between the second cavity 1605b and the third cavity 1605c. A plurality of metal traces 1626 may connect the plurality of metal bars 1622 to form a through-glass via inductor 1600. The metal traces 1626 may be perpendicular with the metal bars 1622. The metal traces 1626 may connect to the top and bottom surfaces of the metal bars 1622 to form a series of turns for the through-glass via inductor 1600. In such an arrangement, a top trace may be offset at an angle with a bottom trace. An electrical current may flow along a top trace, down through a metal bar, along a bottom trace, and up through another metal bar, and so forth. The electrical current, therefore, can follow a roughly spiral-shaped path in the through-glass via inductor 1600. As illustrated in the example in FIG. 9A, the metal bars 1622 and the metal traces 1626 form a through-glass via inductor 1600 having 3.5 turns.

While not shown with respect to FIG. 9A or 9B, other arrangements with respect to the metal traces 1626 and the metal bars 1622 also may be implemented to form a through-glass via inductor 1600. In some implementations, the plurality of metal bars 1622 may be perpendicular to the second cavity 1605b and the third cavity 1605c. The plurality of metal traces 1626 may be arranged at angles with respect to the metal bars 1622 to connect the metal bars 1622. Capacitive coupling between the metal bars 1622 in the vias may be minimized by optimizing the through-glass via diameter and pitch, which determines the pitch of the metal traces 1626. For example, if the through-glass via diameter is about 40 μm and about 100 μm, then the pitch may be between about 1.5 and about 2.0 times the diameter to ensure minimal effect of capacitive coupling.

In the example in FIG. 9A, the cavities 1605a, 1605b and 1605c may be channels or trenches. The channels or trenches may be parallel to one another. The through-glass via inductor 1600 may surround the channel or trench corresponding to the first cavity 1605a. The channels or trenches outside corresponding to the second cavity 1605b and the third cavity 1605c may be outside the through-glass via inductor 1600. Each of the cavities 1605a, 1605b and 1605c may be filled with magnetic material (not shown) to increase the inductance of the through-glass via inductor 1600.

FIG. 9B is an example of a cross-sectional schematic top view of a through-glass via inductor with interconnected cavities forming a single continuous cavity. Each of the cavities 1605a, 1605b and 1605c may be formed in the glass substrate 1602 and interconnected with one another. As illustrated in the example in FIG. 9B, the cavities 1605a, 1605b and 1605c are connected to each other at the front and rear ends of the through-glass via inductor 1600. For example, the cavities 1605a, 1605b and 1605c may be connected to each other in a “figure-8” shaped configuration. However, a person having ordinary skill in the art will readily understand that the cavities 1605 a, 1605b and 1605 c may be connected to one another in alternate configurations. The through-glass via inductor 1600 includes a plurality of metal bars 1622 connected by a plurality of metal traces 1626 to surround the first cavity 1605a. The cavities 1605a, 1605b and 1605c may be filled with magnetic material (not shown) to increase the inductance of the through-glass via inductor 1600. By connecting each of the cavities 1605a, 1605b and 1605c and depositing magnetic material therein, the through-glass via inductor 1600 can preserve continuous coupling of the magnetic field.

FIG. 10 is an example of a cross-sectional schematic side view of a through-glass via inductor 1700 with multiple cavities and magnetic coatings on metal traces of the inductor. A glass substrate 1702 may be provided having a thickness between about 30 microns and about 1 millimeter. The glass substrate 1702 may have a first cavity 1705a, a second cavity 1705b and a third cavity 1705c, where the first cavity 1705a is between the second cavity 1705b and the third cavity 1705c. In some implementations, each of the cavities 1705a, 1705b and 1705c may be blind vias that extend only partially through the glass substrate 1702.

The through-glass via inductor 1700 may be similar to the through-glass via inductor 1500 provided in FIG. 8F, or the through glass via inductor 1600 in FIGS. 9A and 9B. The through-glass via inductor 1700 may include metal bars 1722 connected by metal traces 1724 that are substantially perpendicular with one another. The metal bars 1722 and the metal traces 1724 may include electrically conductive material. The metal bars 1722 and the metal traces 1724 may form a plurality of turns to surround the first cavity 1705a. The second cavity 1705b and the third cavity 1705c may be disposed outside of the through-glass via inductor 1700.

Each of the cavities 1705a, 1705b and 1705c may be filled with magnetic material (not shown). As discussed earlier herein, this arrangement increases the magnetic field and confines to the magnetic flux to further improve the inductance. Here, the through-glass via inductor 1700 may further include a magnetic coating 1728 above the through-glass via inductor 1700 or below the through-glass via inductor 1700, or both above and below the through-glass via inductor 1700. The magnetic coating 1728 may be deposited on the metal traces 1724 using any suitable deposition technique. The magnetic coating 1728 may be patterned using a technique such as photolithography. In some implementations, the magnetic coating 1728 may form an overhang extending beyond the metal traces 1724. In some implementations, the magnetic coating 1728 may be made of a ferromagnetic or ferrimagnetic material, such as ferrite. The thickness of the magnetic coating 1728 may be between about 0.1 μm and about 10 μm. By having magnetic material above and below the through-glass via inductor 1700, in addition to having magnetic material outside to the left and to the right of the through-glass via inductor 1700, the magnetic field increases and further confines magnetic flux to improve inductance. This arrangement also may reduce stray magnetic flux with other sensitive electrical components and decrease parasitic inter-device coupling with any neighboring structures. Magnetic field coupling may further increase with the magnetic core to increase inductance.

In some implementations, any of the through-glass via inductors disclosed herein can have a solenoidal configuration. In some implementations, any of the through-glass via inductors disclosed herein may have a toroidal configuration. In some implementations, a transformer may be realized using a pair of toroidal-shaped through-glass via inductors fabricated using the techniques described herein. The through-glass via inductors described herein may be utilized in any number of electromagnetic structures, including various antenna configurations, and are not limited to the aforementioned configurations.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

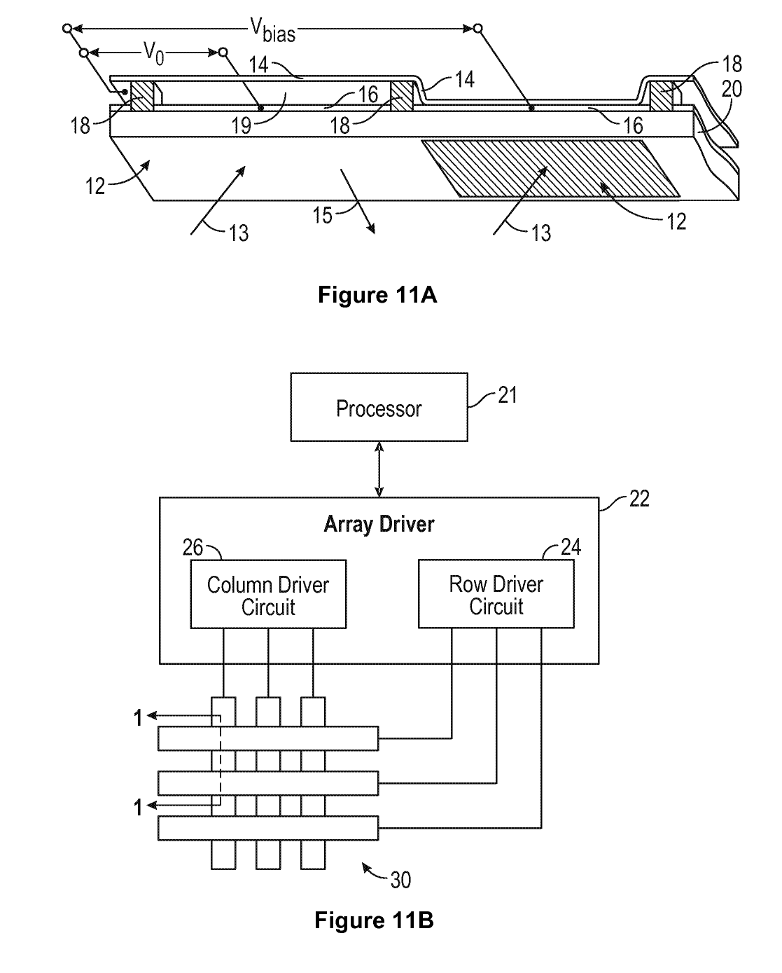

FIG. 11A is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 11A includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 11A, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 11A and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (such as chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (such as of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 11A, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 11A. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 11B is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 11A is shown by the lines 1-1 in FIG. 11B. Although FIG. 11B illustrates a 3×3 array of IMOD display elements for the sake of clarity, the display array 30 may contain a very large number of IMOD display elements, and may have a different number of IMOD display elements in rows than in columns, and vice versa.

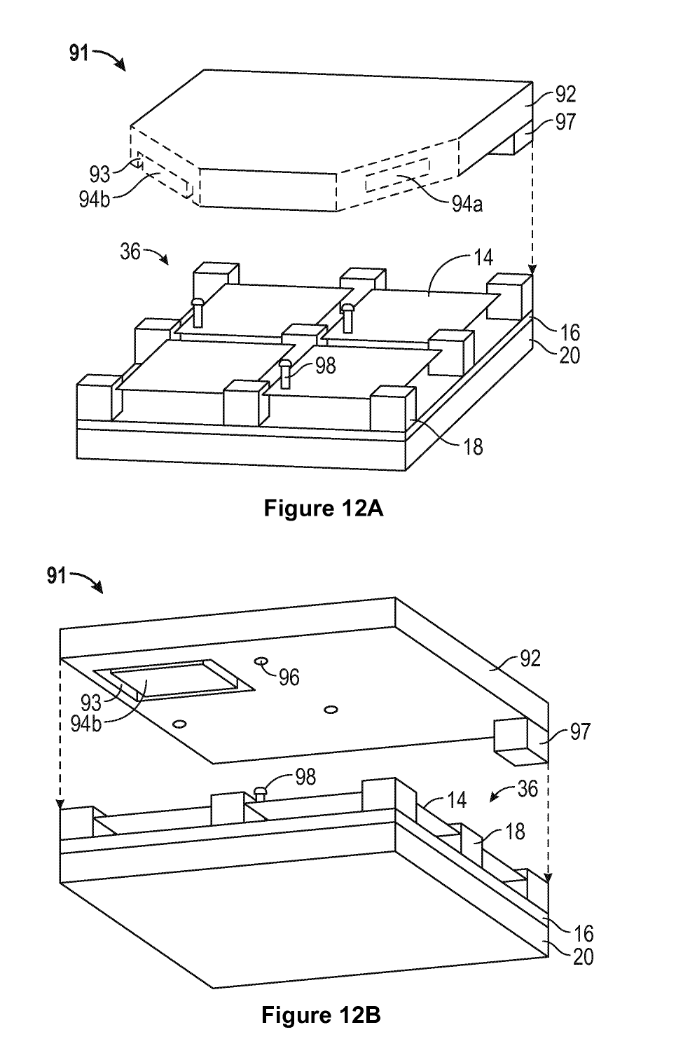

FIGS. 12A and 12B are schematic exploded partial perspective views of a portion of an EMS package 91 including an array 36 of EMS elements and a backplate 92. FIG. 12A is shown with two corners of the backplate 92 cut away to better illustrate certain portions of the backplate 92, while FIG. 12B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (such as the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 12A and 12B, the backplate 92 can include one or more backplate components 94a and 94b, which can be partially or wholly embedded in the backplate 92. As can be seen in FIG. 12A, backplate component 94a is embedded in the backplate 92. As can be seen in FIGS. 12A and 12B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 12B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 12A and 12B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 12A and 12B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

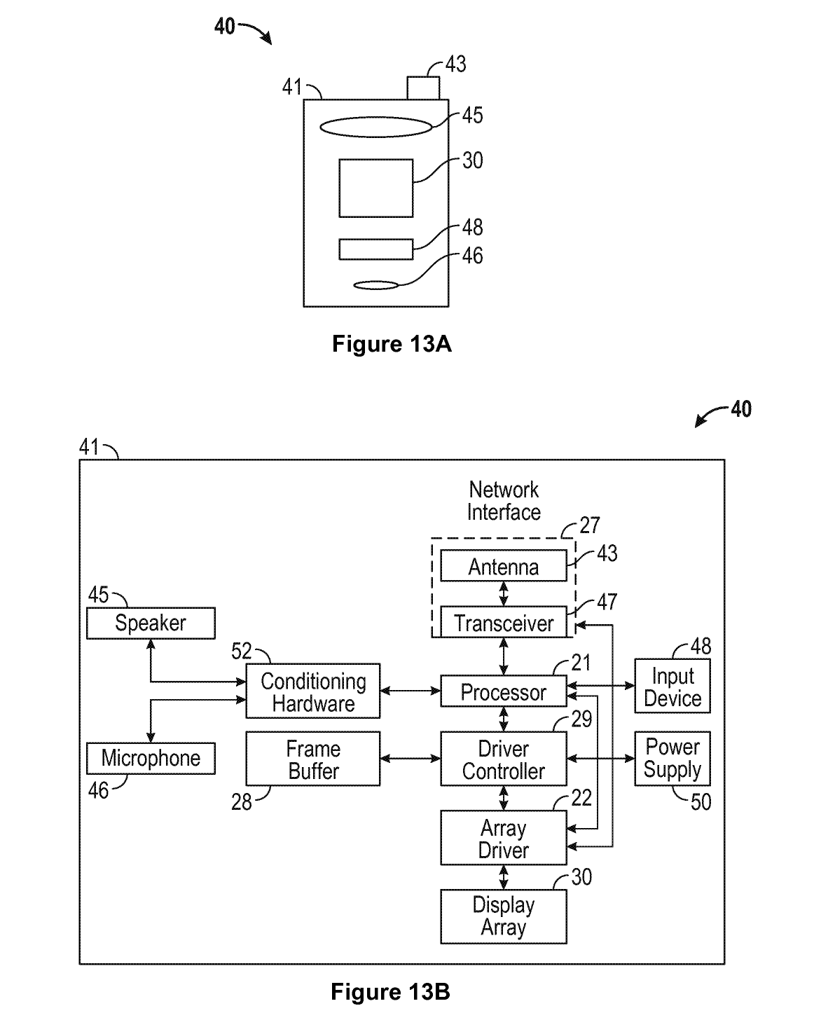

FIGS. 13A and 13B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 13A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, such as an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a glass substrate;
a first cavity defined in the glass substrate;
a second cavity defined in the glass substrate, wherein magnetic material is disposed in both the first and the second cavity;
at least two through-glass vias extending through the glass substrate, wherein the at least two through-glass vias include metal bars, and wherein the first cavity is between the through-glass vias and at least one of the through-glass vias is between the first cavity and the second cavity; and
a metal trace connecting the metal bars between the at least two through-glass vias.

2. The device of claim 1, wherein the magnetic material includes a plurality of magnetic particles, the average diameter of the particles being less than about 20 nm.

3. The device of claim 2, wherein the magnetic particles include ferrite.

4. The device of claim 2, wherein the magnetic particles are substantially coated with insulating material.

5. The device of claim 4, wherein the average thickness of the coating is between about 5 nm and about 100 nm.

6. The device of claim 4, wherein the insulating material includes silicon oxide (SiOx).

7. The device of claim 1, further comprising a third cavity defined in the glass substrate, wherein magnetic material is disposed in the third cavity, and wherein the metal bars are between the second cavity and the third cavity.

8. The device of claim 1, further comprising a magnetic coating disposed on the metal trace.

9. The device of claim 1, wherein the first cavity and the second cavity are connected with each other to form a continuous cavity within the glass substrate.

10. The device of claim 1, wherein each of the first and the second cavity is a via extending only partially through the glass substrate.

11. The device of claim 1, wherein the glass substrate includes a photoimageable glass.

12. The device of claim 1, wherein the glass substrate has a thickness between about 30 microns and about 1 millimeter.

13. The device of claim 1, wherein the metal trace and the metal bars define at least a portion of one of a plurality of metal turns arranged in a solenoidal inductor.

14. The device of claim 1, the metal trace and the metal bars define at least a portion of one of a plurality of metal turns arranged in a toroidal inductor.

15. An apparatus comprising:
the device of claim 1;
a display;
a processor that is configured to communicate with the display, the processor being configured to process image data; and
a memory device that is configured to communicate with the processor.

16. The apparatus of claim 15, further comprising:
a driver circuit configured to send at least one signal to the display; and
a controller configured to send at least a portion of the image data to the driver circuit.

17. The apparatus of claim 15, further comprising:
an image source module configured to send the image data to the processor, wherein the image source module comprises at least one of a receiver, transceiver, and transmitter; and
an input device configured to receive input data and to communicate the input data to the processor.

18. A method comprising:
providing a glass substrate;
forming at least two through-glass vias extending through the glass substrate;
forming a first cavity in the glass substrate, wherein the first cavity is between the at least two through-glass vias;
forming one or more second cavities in the glass substrate, wherein at least one of the through-glass vias is between the first cavity and the one or more second cavities;
depositing magnetic material in the first cavity and the one or more second cavities;
depositing a metal to at least partially fill the through-glass vias to form metal bars in the through-glass vias; and
depositing a metal trace between the through-glass vias to connect the metal bars.

19. The method of claim 18, wherein the magnetic material includes a plurality of magnetic particles, the average diameter of the particles being less than about 20 nm.

20. The method of claim 19, wherein the magnetic particles include ferrite.

21. The method of claim 19, further comprising coating the magnetic particles with insulating material.

22. The method of claim 21, wherein the average thickness of the coating is between about 5 nm and about 100 nm.

23. The method of claim 21, wherein the insulating material includes silicon oxide (SiOx).

24. The method of claim 18, further comprising forming a magnetic coating on the metal trace.

25. The method of claim 18, wherein forming the first cavity and forming the one or more second cavities includes connecting the first and the one or more second cavities to form a continuous cavity.

26. The method of claim 18, wherein each of the first cavity and the one or more second cavities is a via extending only partially through the glass substrate.

27. The method of claim 18, wherein forming the at least two through-glass vias includes:
exposing an area of the glass substrate to ultraviolet radiation;
exposing the glass substrate to an elevated temperature; and
etching the area of the glass substrate to form the at least two through-glass vias.

28. The method of claim 18, wherein forming the first cavity and the one or more second cavities includes:
exposing an area of the glass substrate to ultraviolet radiation;
exposing the glass substrate to an elevated temperature; and
etching the area of the glass substrate to form the first cavity and the one or more second cavities.

29. The method of claim 18, wherein forming the at least two through-glass vias and forming the first and the one or more second cavities occur simultaneously or at different times.

30. The method of claim 18, wherein forming the at least two through-glass vias includes at least one of a sandblasting process, a laser ablation process, a glass forming process, an ultrasonic drilling process, and an etch process.
